(19) United States
(12) Patent Application Publication
(10) Pub. No.: US 2008/0205630 A1
(43) Pub. Date: Aug. 28, 2008

(54) Method and system for entering and managing a caller in a call queue via an untethered form of communication

(76) Inventor: Akshay Kumar Deshpande, Fremont, CA (US)

Correspondence Address: Akshay K. Deshpande, 34077 Paseo Padre Parkway, #108, Fremont, CA, 94555, US

(21) Appl. No.: 11/943,580

(22) Filed: Nov. 20, 2007

Related U.S. Application Data
(60) Provisional application No. 60/866,748, filed on Nov. 21, 2006.

(51) Int. Cl. H04M 3/00

(52) U.S. Cl. 379/266.01

(57) ABSTRACT

A method, system and program for entering a prospective caller in a call queue, specifically to a selection of methods and systems allowing a caller to enter a call queue utilizing an untethered form of communication based on information conveyed over a network that does not originate from a telephone or softphone. A prospective caller, who would normally use a telephone to call and enter a call queue, can do so with other means over the network, such as Instant Messaging, E-Mail, SMS, etc. When the system receives such a request, it is placed in the appropriate call queue and handled in manner similar to a call made from a telephone, not requiring the caller to hold on the telephone while in the queue.

### CROSS REFERENCES TO RELATED APPLICATIONS

The present application claims the benefit of U.S. Provisional Patent Application No. 60866748 filed Nov. 21, 2006 by Akshay K. Deshpande, the present inventor. Said application is incorporated herein by reference.

A method and system for entering and managing a caller in a call queue via an untethered form of communication.

### FEDERALLY SPONSORED RESEARCH

Not applicable.

### SEQUENCE LISTING OR PROGRAM

Not applicable.

### TECHNICAL FIELD

The present invention relates to management of a call queue, and specifically to a selection of methods and systems allowing a caller to enter a call queue utilizing an untethered form of communication based on information conveyed over a network that does not originate from a telephone or softphone.

### BACKGROUND OF INVENTION

Telephones are very frequently used and it is common that a caller calling a large company is placed in a call queue where the caller has to wait until someone is ready to talk to the caller. A variety of telephone systems handle such call queues. Systems often require the caller to use a telephone to first call into such a system and then enter through a call queue in order to be able to talk to some one in the company. In such situations, either the company or the caller often must pay long distance or cellular airtime charges. Additionally, the act of waiting in a call queue ties up valuable telephone lines or bandwidth. Call centers are designed to optimize call handling efficiency in order to serve a maximum number of callers. Often, even in spite of the optimizations, callers still spend considerable time waiting in call queues.

A goal of all call queuing systems is to ultimately minimize attendant idle time while remaining reachable to the customers. A side effect is the increased duration of time spent holding. Elongated hold times may mean the customer has to hang on to the connection as well as the telephone to get service. During busy periods, the number of callers in the queue will tie up communication lines or use bandwidth making it difficult to service some customers. Situations like these tend to ward off customers as well as increase the cost of providing service to their customers.

Call distribution systems have been developed to deal with these issues. One method involves queuing the callers. When the called party or its agent is unavailable to answer the call immediately, the call distribution system places the caller in call queue. Incoming call or calls in a queue can then also be distributed to a multitude of available agents or attendants. Information about the caller may also be stored and analyzed by the called company in order to give priority to certain pre-selected group of customers. These types of call queuing systems are usually implemented in a Private Branch Exchange (PBX) or Automatic Call Distribution (ACD) system. A PBX is a telephone exchange that serves a particular business or office, as opposed to one that a common carrier or telephone company operates for many businesses or for the general public. ACD is a device or system that distributes incoming calls to a specific group of terminals that agents use. It is often part of a computer telephony integration system. A salient feature of the traditional PBX/ACD systems is that they only handle telephones calls and place only telephone calls into a call queue. This often requires maintaining an active telephone connection.

The propagation of modern communication software and hardware system in both business and among the public at large has given rise to many new means of communicating such as email, via web sites, Instant Messaging (IM), Short Messaging Service (SMS), etc. Modern PBX/ACD systems are capable of interfacing with these types of external systems providing additional flexibility and functionalities previously unrealized in the field of call queuing. Where the traditional PBX/ACD system merely handled telephones calls and placed only telephone calls into a call queue, the present invention allows untethered communications to interface with call queuing systems. This innovation extends the capabilities of traditional PBX/ACD systems further optimizing their efficiency for handling calls and at the same time boosting convenience for callers.

The methods of the present invention allow for the creation of systems which remove the waste associated with the tied up telephone lines and bandwidth that results in callers maintaining an active connection with a telephone. A caller need not wait in a call queue, but may instead choose to be called back. The caller can provide this call back information to a queuing system by means of untethered communication based on information conveyed over a network. For example, the caller sends an instant message, a form of untethered communication conveyed over a network, transmitting information to a queuing system such that the queuing system can then place the caller in a call queue. An advantage of this method is that no active connection need be maintained. The present invention does not rely on telephones and the concomitant requirements involved in maintaining an active connection to preserve placement in a call queue or the need for the caller to leave a message.

### BRIEF SUMMARY OF THE INVENTION

The present invention relates to entering a caller into a call queue without having to call in using a telephone or softphone. The present invention further relates to managing the caller's request. Illustrative embodiments of the present invention include methods and systems enabling callers to enter a call queue, delay their entry in a call queue or delete their pending request, all without having to call in using a telephone or softphone.

Embodiments of the preferred invention include a method or system which may enter and handle a request in a call queue without using a telephone or an active connection similar to that of telephone or a softphone. For instance, a caller wants to contact another person or business where a call could be placed in a queue, the caller may use other means of communications besides a telephone, such as email, via a web browser or web page, web server, instant messaging (IM), short messaging service (SMS) and other similar interfaces or programs, to initiate the call. The request is placed in a queue on behalf of a caller. While a caller may be waiting to receive a call, the status can be updated on any one of the originating, predetermined or selected communication facilities. When the request is about to be serviced, the caller will be informed about the impending call. If the caller does not respond to the call or is unavailable, the request may be handled in multiple ways. The caller may also have the ability to cancel a pending request as well as delaying entry of the request in the call queuing system by utilizing the above referenced means of communication which does not include telephones or softphones.

### BRIEF DESCRIPTION OF THE SEVERAL VIEWS OF THE DRAWINGS

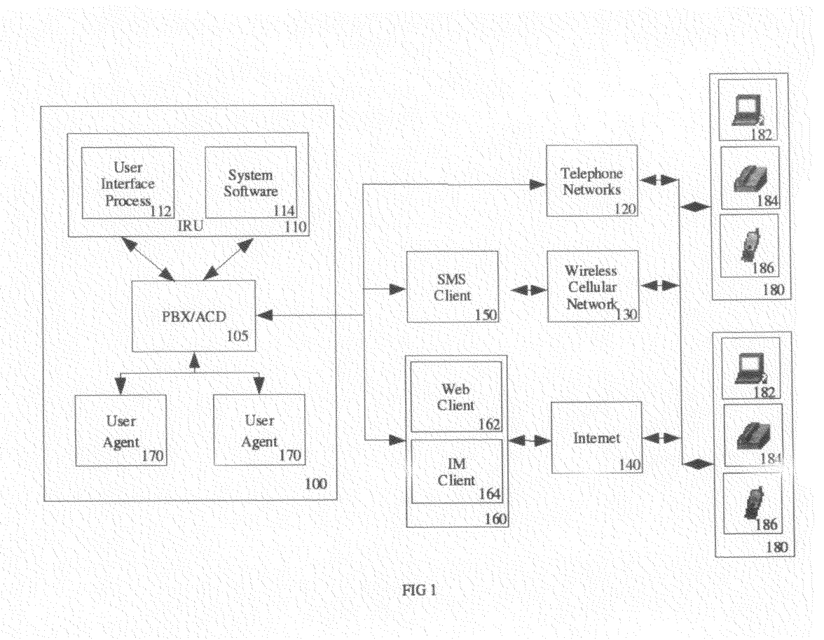

Example FIG. 1 is a schematic block diagram of a communication switching system, in accordance with embodiments.

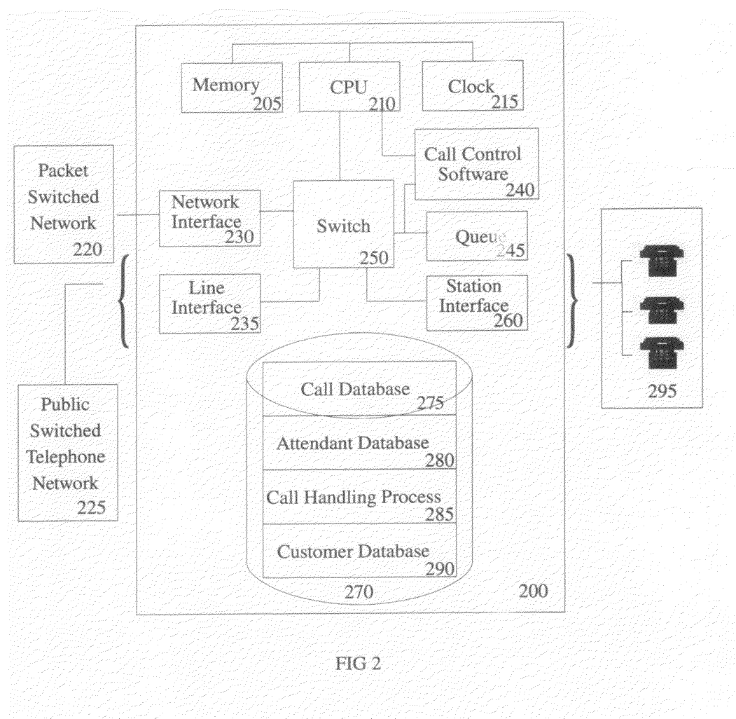

Example FIG. 2 is a schematic block diagram of the PBX/ACD, in accordance with embodiments.

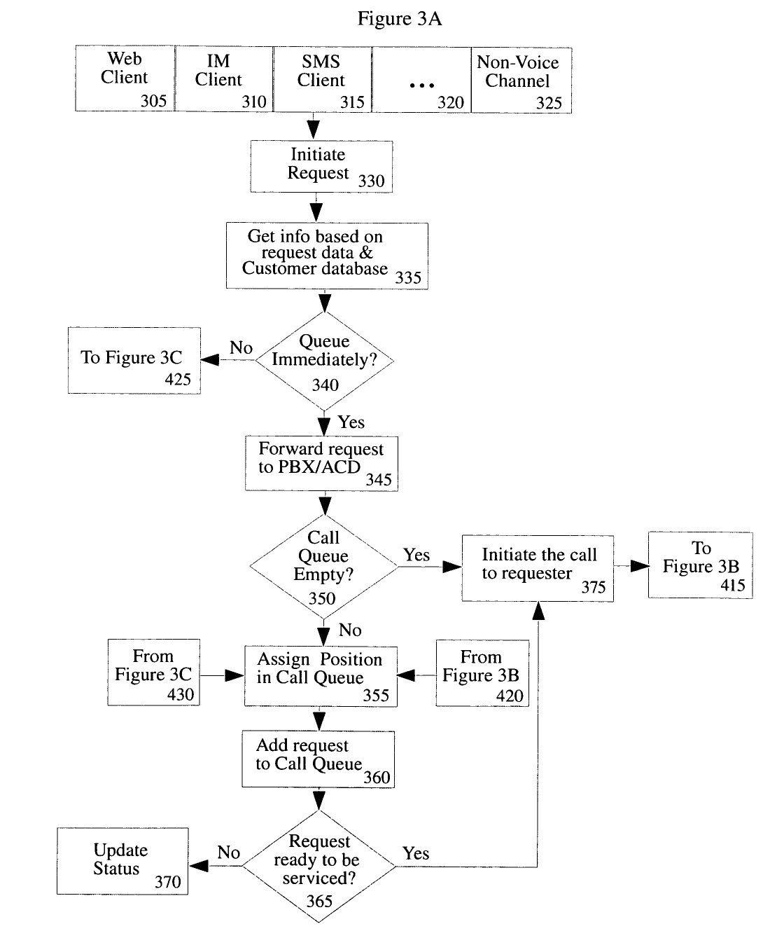

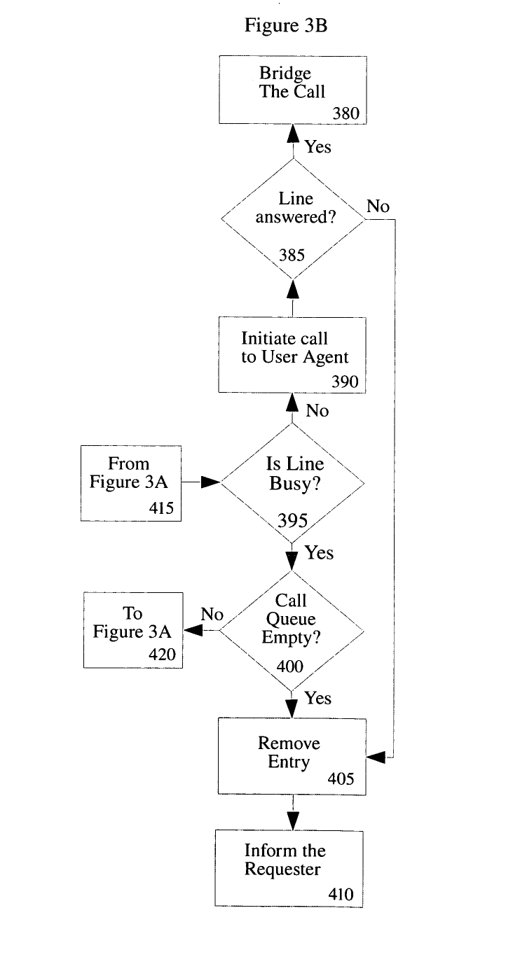

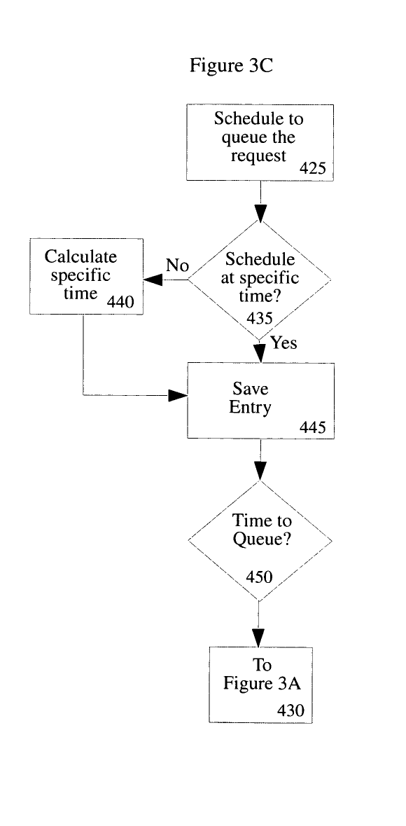

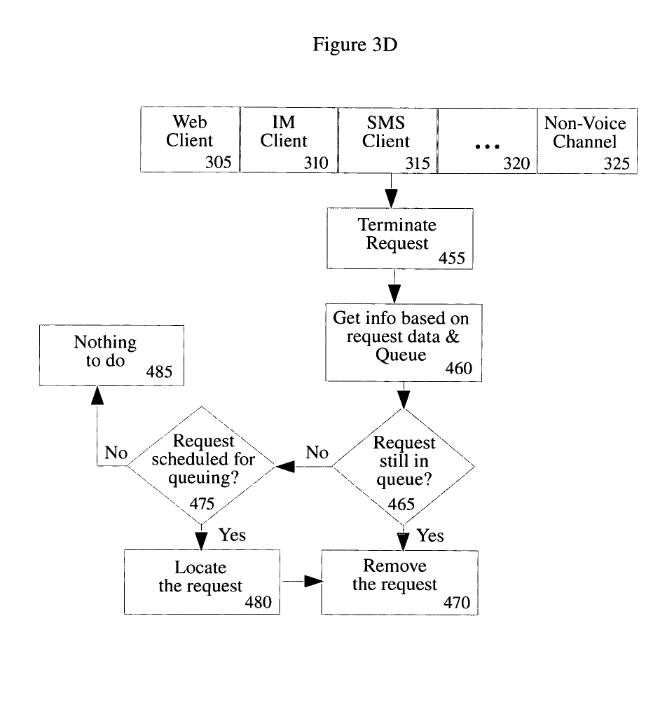

Example FIGS. 3a, 3b, 3c and 3d illustrate flow diagrams describing an example call queue entry process, in accordance with embodiments.

### DETAILED DESCRIPTION OF THE INVENTION

The present invention involves a selection of methods and business methods allowing caller to enter a call queue utilizing an untethered form of communication based on information conveyed over a network and without the need to maintain an active connection with the called queuing system.

An example preferred embodiment involves a method or system which enters a caller in a call queue without using a telephone or softphone. The caller enters the call queue by utilizing an available interface, not a telephone, including, but not limited, to email, web browser or web page, web server, instant messaging (IM), short messaging service (SMS) and other similar interfaces or programs. The caller is, in effect, entering the call queue as if the caller had come into the system using a telephone. The caller may be presented, on any of the interfaces, with a choice of call queues so that an appropriate queue can be selected to enter. A request can specify when the caller wants to enter the queue, either after specified amount of time or at a particular time of the day. Or when a request from caller comes in, if agent is available immediately, then a call is placed to the caller and the agent is connected immediately. If no agent is available, then the request may be placed in the call queue as if the caller had called and the request is handled in the normal sequence. This relieves the caller of the frustration due to waiting in the queue and not having the flexibility to move away from the phone. It also helps the called system by not having to tie up a phone line, bandwidth or other valuable resources to maintain the caller in a queue.

In a more specific illustrative example of this particular embodiment of the invention, a caller sends an instant message via a personal computer to a company utilizing the method or system of the present invention. The instant message enters the caller in a calling queue, and when the next available user agent for the company becomes available, the user agent contacts the caller according the caller's particular place in the calling queue. A request may be removed from the system when either the call is successfully completed, or the caller does not respond to the call initiated due to the request, or a predetermined number of attempts of callback have been tried, or if predetermined amount to time has passed since the initial request was made.

A request can also specify how long the request is valid. After such time has expired, the request may be canceled. After the caller sends in the request to be placed in a call queue, the caller can decide to cancel the request. The caller can send in another request which contains the identification, which identifies the queued call request, to cancel the impending call. If such request still exists in the system, then the request is removed, otherwise no actions needs to be taken.

An embodiment of the present invention will now be described with reference to FIG. 1. FIG. 1 depicts a block diagram of a network environment. While some embodiments are described with reference to one type of network environment, it will be understood by one with skill in the art, that embodiments may be implemented in alternate types of network environments.

First, the network environment incorporates a public switching telephone network (PSTN) 120, wireless cellular network 130 or Internet 140. As is known in the art the core of a PSTN 120, wireless cellular network 130 or Internet 140 may include multiple networks, each owned by one of multiple independent service providers.

Untethered form communication refers to any communication with an originating or calling person or party does not have to be connected to the target or destination party at the time when a communication takes place. Illustrative examples of such forms of communication are email, instant message or short message service. Tethered forms of communication requires both the caller and destination party to be connected in order to start communications. Examples this type of communication are the telephone and softphone.

A web page, identified by a uniform resource locater (URL), is a document connected to the World Wide Web and viewable by anyone connected to the Internet using a computer 182 or any such similar device which has a web browser. A web page can be in any format that the browser or a helper application can display. It is also possible for the server to generate pages dynamically in response to a request, e.g. using a CGI script.

Instant messaging (IM) refers to exchanging messages in real time between two or more people. Unlike a system such as the telephone, IM requires that both parties be logged onto their IM service at the same time. To access an IM service, a user registers with a service provider and, after connecting to the Internet (or other appropriate data network), enter their screen name and password to log in to the IM network. Once a user has logged in to an appropriate IM network, their presence on the system is made known to all authorized partners. The user can then engage in typed conversations with other IM users connected to the system.

Short Messaging Service (SMS) is a text message service that enables short messages of generally no more than 140-160 characters in length to be sent and transmitted from a mobile telephone.

FIG. 1 shows an illustrative network environment for transferring information, between a caller a call center 100 call queue using a web page, web client or IM client from a computer or using a SMS service on a mobile telephone 186, to enter in a call queue of a call center 100, so that the caller can later receive a call on telephone set 184, when a user agent 170 becomes available. According to a feature of this embodiment of the present invention, the call center 100 enables a caller to be placed in a call queue even without having to call with a telephone to the call center 100.

The PBX/ACD 105 may be embodied, for example, using the Digium. Asterisk® IP PBX with Automatic Call Distribution (ACD) capability, as modified herein to execute the functions and operations of an embodiment of the present invention. The PBX/ACD is discussed more fully below in conjunction with FIG. 2. Generally, the PBX/ACD is a switching system designed to receive calls destined for call center, and queue them when an appropriate user agent is not available. In addition, the PBX/ACD distributes calls to user agents or specific groups of agents according to a prearranged scheme, such as a hunt group, to ensure even call handling loads among attendants, in a known manner. The ACD functionality can be integrated with the PBX, as in the illustrative embodiment shown in FIG. 1, or provided by a separate unit.

The IRU 110 is an interactive response unit (IRU) which may be arranged to (i) prompt a caller or (ii) provide selection choices for specific information to a caller (iii) interacting with the caller using one of the interfaces of callers choice and (iv) collect that information from the caller, (v) organize the collected information in a specific format and (vi) forward the collected information to the PBX/ACD 105.

Generally, the IRU includes a central processing unit (CPU) (not shown) which executes a user interface process 112, embodied as a email agent (not shown), CGI Script (not shown) or Web Handler (not shown), IM client or handler (not shown) or SMS handler (not shown) and system software 114, embodied as a combination of an operating system (not shown), Web Server (not shown), IM Server (not shown) or SMS Server (not shown). The user-interface process includes a transaction script including a sequence of menus or query messages posed to a caller to elicit answers in the form of the originating interface, whether it be an email, a web page or web client 162, IM client 164, SMS client 150 or any other such interface not including telephone or softphone. The modules of a transaction script are executed in a specified order (which may vary based on the caller's responses) to direct callers to enter specific information to enter their request in the appropriate call queue. The system software, on the other hand, includes primitives to interact with the interface, including but not limited to email via Mail Transport Unit (MTU), Hyper Text Transfer Protocol (HTTP) via a web server, IM server, and SMS server. The IRU functionality can be integrated with the PBX/ACD or provided as a separate unit as shown in FIG. 1.

The PBX/ACD 105 and the IRU 110 may transmit digitally encoded data and other information, including voice signals, between one another. The transmitted data and other information may represent caller name and identification number, specific information entered by the caller to enter the call queue. The communications link between the PBX/ACD 105 and the IRU 110 preferably comprises a cable or wireless link on which electronic signals can propagate, when not the IRU 110 functionality is not integrated within the PBX/ACD 105.

The initial communication from the caller may originate from an email, a Web client, IM client, SMS or any other such software or device, not including a telephone or softphone, transmitted over the Internet 140 or wireless cellular network 130 to the IRU 110. The IRU may then communicate with the PBX/ACD 105 as well as any other database to get relevant information regarding the caller.

Once a user agent 170 is available, the call request IRU 155 preferably plays a short message to the caller indicating that the call is being connected to a live attendant and transfers the call along with the collected data to the PBX/ACD 150. The collected information is thereafter forwarded by the PBX/ACD 150 to an available attendant console 160 for display to the attendant who handles the call. Each attendant console 160 preferably includes a station set and an associated console or general purpose computer to enter or receive data required to complete a transaction with a caller.

The telephone network 120, as used herein, includes the combination of local and long distance wired or wireless facilities and switches known as the public switched telephone network (“PSTN”), as well as a wireless cellular network 130 systems and the telephony feature of the Internet 140. Once an user agent 170 is available, the telephone network 120 is utilized to complete calls between (i) a caller at a station set, such as station sets 182, 184, 186, and the call center 100; and (ii) an user agent 170. The caller is typically identified using the information provided during the initiation of the request. The collected information is thereafter forwarded by the PBX/ACD 105 to an available User Agent 160 for display to the attendant who handles the call. Each User Agent 170 is equipped with a station set and an associated console or general purpose computer to enter or receive data required to complete a transaction with a caller.

Example FIG. 2 is a block diagram showing the architecture of an illustrative PBX/ACD 105, in accordance with embodiments. As previously indicated, the PBX/ACD 105 may be embodied, for example, using the Digium. Asterisk® IP PBX with Automatic Call Distribution (ACD) capability, as modified herein to execute the functions and operations of the present invention. The PBX/ACD 105 preferably includes certain standard hardware components, such as a CPU 210, a data storage device 270, a random access memory (RAM) 205, a clock 215, and interface cards, such as a network interface 230 or a line interface 235, that connect the PBX 105 to outside communications lines, such as PSTN 225 or Packet Switched Network 220 (or Internet 140). The CPU 230 is preferably linked to each of the other listed elements, either by means of a shared data bus, or dedicated connections, as shown in FIG. 2. The PBX also may also contain station interface cards 260 that adapt the PBX signals to the type of PBX extensions (PBX telephones) that are used with the system. The PBX unit additionally contains a switch 250, which is functionally used to interconnect stations to other stations or to outside lines. PBX call control software 240 coordinates the overall operation of the PBX system, while the queue 245 stores indicators describing the order in which calls or call request, a feature of the present invention, were directed to the call center 100.

The CPU 210 may be embodied as a single processor, or a number of processors operating in parallel. The data storage device 270 or RAM 205 is operable to store one or more instructions, which the CPU 210 is operable to retrieve, interpret and execute. The RAM 205 preferably stores the queue 245 of indicators describing the order of the queued calls directed to the call center. The CPU 210 preferably includes a control unit, an arithmetic logic unit (ALU), and a CPU local memory storage device, such as, for example, a stackable cache or a plurality of registers, in a known manner. The control unit is operable to retrieve instructions from the data storage device 270 or RAM 205. The ALU is operable to perform a plurality of operations needed to carry out instructions. The CPU local memory storage device is operable to provide high speed storage used for storing temporary results and control information.

Data storage device 270 may include a call database 275, an attendant database 280, a call handling process 285, discussed further below, and a customer account database 290. The customer account database 290 stores information on each customer, such as biographical information, telephone numbers to contact, email-address and IM screen name. As such, the customer account database is an illustrative example of a customer data storage means. The call database 275 stores information on each call or call request being processed by the call center 100, including an indication of the position of the call or call request within the queue 245. The attendant database 280 stores information on each user agent, including an indication of the availability status of each user agent and their respective expertise.

Generally, the call handling process 285 consists of many sub-processes, which allows PBX/ACD 105 to perform its function. One such sub-process allows PBX/ACD 105 to (i) receive a call directed towards on of the user agents, (ii) place the call in the queue, if needed, (iii) initiate a call on behalf of its users, if needed, as per call request (iv) route a call to an appropriate user agent console 295 within a pool of user agents 170, and (v) terminate the call. Example FIGS. 3a, 3b, 3c and 3d are flow diagrams illustrating call handling process 285 in accordance with an example preferred embodiment. This process 285 is illustrated with reference to the architecture outlined in FIGS. 1 and 2, however, it should be noted that the process will work equally well in other architectures that perform call queuing functions. The process begins with any one of the steps 305, 310, 315, or 325 when a caller initiates a request 330 to contact the call center 100 using any one of the interfaces, 305, 310, 315 or 325, not including a telephone or softphone. Based on the interface, information regarding caller is gathered 335 and the information to contact the caller is retrieved from customer database 290. If the request is to contact immediately 340, call queue is empty, then the request is forwarded 345 to the PBX/ACD 105. If the call queue is not empty then the request is queued 360 along with other pending calls and requests. The position in the call queue is determined 355 depending on the request information and customer data retrieved.

When the request is ready to be serviced 365 or when the call queue is empty on receiving request 350, a call is placed, using the data retrieved 335, to contact the caller. At the same time status information is sent to the callers interface, 305, 310, 315, or 325. Note that the status information can be sent to an interface which is not necessarily the initiating interface. While the request is not ready to be serviced, the status information is updated 370 at regular intervals, if not continuously. If the called line is busy and the call queue is empty then the request is removed 405 from the system and the requester is informed 410 of the removal. If the called line is not busy then the user agent is connected 390 and when the user agent answers 385, the call is transferred to the user agent 380. If the call queue is not empty, then the request is added back 420.

If the request is to schedule an entry 425 to be added to the call queue at a later time 435, then the request is stored 445 until such time, time can be specified as time of day or amount of time from request time. If the time is specified in terms of the amount of time that needs to be added to the request time, then the time of the day is calculated 440 and then stored. When the time has reached to queue the call 450, then the request is entered 430 in the call queue as if it had just come in.

Once the request has been made 330, the requester prior to completion of the call request, can request to cancel the original request. The requester can use any of the interfaces, 305, 310, 315, or 325, to terminate 455 the pending request, while providing identification for the original request. Based on the information provided in the request 455, the pending request is located 460. If the pending request is still 465 in the call queue 360, then it is removed. If the pending request was saved 445 to be scheduled in the queue 475, then it is located 480 and then removed 470 from system. If the pending request cannot be located, then nothing needs to be done. This could be due to incorrect identification.

It is important to note that while embodiments have been described in the context of a fully functioning data processing system, those of ordinary skill in the art will appreciate that the processes of embodiments are capable of being distributed in the form of a computer readable medium of instructions and a variety of forms and that aspects of embodiments apply equally regardless of the particular type of signal bearing media actually used to carry out the distribution. Examples of computer readable media include recordable-type media, such as a floppy disk, a hard disk drive, a RAM, CD-ROMS, DVD-ROMS, and transmission-type media, such as digital and analog communications links, wired or wireless communications links using transmission forms, such an, for example, radio frequency and light wave transmissions. The computer readable media may take the form of coded formats that are decoded for actual use in a particular data processing system. Illustrative examples of caller recognition means are caller identification (CID), automatic number identification (ANI) and a calling number identification (CNID). These examples can be included into an embodiment of the present invention.

The description of embodiments has been presented for purposes of illustration and description, and is not intended to be exhaustive or limited to the embodiments in the form disclosed. Many modifications and variations will be apparent to those of ordinary skill in the art. Example embodiments were chosen and described in order to best explain the principles of embodiments, the practical application, and to enable others of ordinary skill in the art to understand the invention for various embodiments with various modifications as are suited to the particular use contemplated. Thus, the scope of the invention should be determined by the appended claims and their legal equivalents, and not by the examples given.

1: A method for placing a caller in a call queue, comprising:
receiving an incoming request from said caller by utilizing an untethered form of communication based on information conveyed over a network except with a telephone, softphone or from a PBX/ACD;
utilizing information from said incoming request to determine a proper call queue placement;
placing said caller in a call queue.

2: The method of claim 1, wherein said form of untethered communication is selected from the group consisting of email, instant message program, a request originating from web page, short message service and a software program used for said communication such that the caller is not required to wait for a response in order to be placed in a calling queue.

3: The method of claims 1 or 2, further comprising relaying said incoming request to a queuing system.

4: The method of claims 1 or 2, further comprising informing said caller of information regarding an estimated hold time.

5: The method of claims 1 or 2, further comprising informing said caller of information regarding the caller's queue position.

6: The method of claims 1 or 2, further comprising allowing said caller to delay for a chosen period of time said incoming request to be placed in said call queue.

7: The method of claims 1 or 2, further comprising determining proper queue placement on the basis of said information provided with said request as well as on the basis of information obtained from a customer database.

8: The method of claims 1 or 2, further comprising allowing said caller to remove a pending incoming request from said call queue.

9: The method of claims 1 or 2, further comprising utilizing a customer data storage means or a caller recognition means for placing said caller into a queue.

10: The method of claims 1 or 2, further comprising an input method without an active telephone connection.

11: A call queue managing system for processing incoming calls, comprising:
means for receiving call when said call originates from computer or a program connected over a network and said call does not originate from a telephone, softphone or PBX/ACD;
means for placing said call in a call queue;
means for managing a call queue;

12: The system of claim 11, wherein said call originates from an untethered form of communication selected from the group consisting of email, instant message program, a request originating from web page, short message service and a software program used for communication such that the caller is not required to wait for a response in order to be placed in a calling queue.
